(19) United States
(12) Patent Application Publication
(10) Pub. No.: US 2019/0064119 A1
(43) Pub. Date: Feb. 28, 2019

(54) LASER ULTRASONIC THERMOGRAPHY INSPECTION

(71) Applicant: SIEMENS ENERGY, INC., Orlando, FL (US)

(72) Inventor: JASON E. WILLIAMS, COCOA, FL (US)

(21) Appl. No.: 15/687,769

(22) Filed: Aug. 28, 2017

(51) Int. Cl. G01N 29/24; G01N 29/22; G01N 21/17; G01N 25/72; G01H 9/00; G01S 5/16

(52) U.S. Cl. CPC G01N 29/2418; G01N 29/228; G01N 21/1717; G01N 2291/02881; G01H 9/008; G01S 5/16; G01N 2291/0231; G01N 25/72

(57) ABSTRACT

A non-destructive method for the condition assessment of a turbine component is provided. A pulsed laser is used to excite a desired surface of the turbine component by directing the pulsed laser at the desired surface to couple ultrasonic energy into the surface of the turbine component. A thermographic image of the desired surface under the influence of the ultrasonic is captured by an image receiver. A system for the non-destructive detection of defects in a material utilizing acoustic thermography is also provided. The system includes a pulsed laser to couple ultrasonic energy into the material, an infrared camera to capture the thermographic image, and a processor communicatively coupled to the infrared camera to receive, store, and analyze the thermographic image.

### BACKGROUND

### 1. Field

The present disclosure relates generally to a method and system for non-destructive inspection of a material, and more particularly, to method and system for condition assessment of a turbine component utilizing laser acoustic thermography.

### 2. Description of the Related Art

In many industrial applications, non-destructive testing methods are used to evaluate components without causing damage. One such application of non-destructive testing uses acoustic thermography to test components of a turbine engine such as turbine blades or vanes, combustor baskets, or a transition component. These components frequently consist of a substrate coated with a thermal barrier coating that protects the substrate from high temperatures and a corrosive environment. For example, coated gas turbine components may require testing to determine the thickness of the thermal barrier coating or whether the coating has any cracking or delaminations, sections where the coated layer has become separated from the substrate. A severe crack or delaminated layer may cause component failure during normal operation of the turbine.

Currently, inspection and testing of coated turbine components, for example, may be done using acoustic thermography in which the surface of the component is excited using a direct contact method such as using an ultrasonic horn. For example, a technician may place a transducer in the form of an ultrasonic horn in contact with the outer surface of a component at a predetermined position(s). The excitation of the surface causes vibrations within a portion of the component sufficiently to reveal flaws over an energized area around the transducer. An infrared camera is then used to capture infrared radiation emitted by the component to form a thermographic image. The flaws would be visible in the thermographic image.

While acoustic thermography enables non-destructive testing of components, there are some disadvantages using ultrasonic horns. For example, directly contacting coated surfaces of a component with the ultrasonic horn may damage the coated surface. Additionally, using ultrasonic horns requires complex adjustment of the horn in order to view all of the desired surfaces of the component which may cause wear of the horn.

Consequently, a non-destructive inspection method that will overcome these disadvantages is desired.

### SUMMARY

Briefly described, aspects of the present disclosure relate to a method for the condition assessment of a turbine component, a system for the non-destructive detection of defects in a material utilizing acoustic thermography, and a method for detecting defects in a material utilizing acoustic thermography.

A non-destructive method for condition assessment of a turbine component is provided. The method includes providing a pulsed laser to excite a desired surface of the turbine component. The pulsed laser is then directed at a desired surface to couple ultrasonic energy into the surface of the turbine component. An image receiver captures a thermographic image of the desired surface of the turbine component.

A system for the non-destructive detection of defects in a material utilizing acoustic thermography is provided. The system includes a pulsed laser to couple ultrasonic energy into the material, an infrared camera comprising an infrared sensor configured to capture a thermographic image of the material under the influence of the ultrasonic energy produced as a result of the ultrasonic energy coupled into the material, and a processor communicatively couple to the infrared camera for receiving, storing, and analysing the thermographic image.

A method for detecting defects in a material utilizing acoustic thermography is provided. The method includes the steps of providing a pulsed laser to excite a desired surface of the material. The laser is directed at the desired surface to couple ultrasonic energy into surface of the material. An image receiver captures a thermographic image of desired surface under the influence of the ultrasonic energy via an image receiver.

### BRIEF DESCRIPTION OF THE DRAWINGS

FIG. 1 illustrates a side partial cross sectional view of an axial flow gas turbine,

FIG. 2 illustrates a diagrammatic view of an acoustic thermography system, and

FIG. 3 illustrates a coated turbine component with a crack involved in a non-destructive method for condition assessment of a turbine component.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

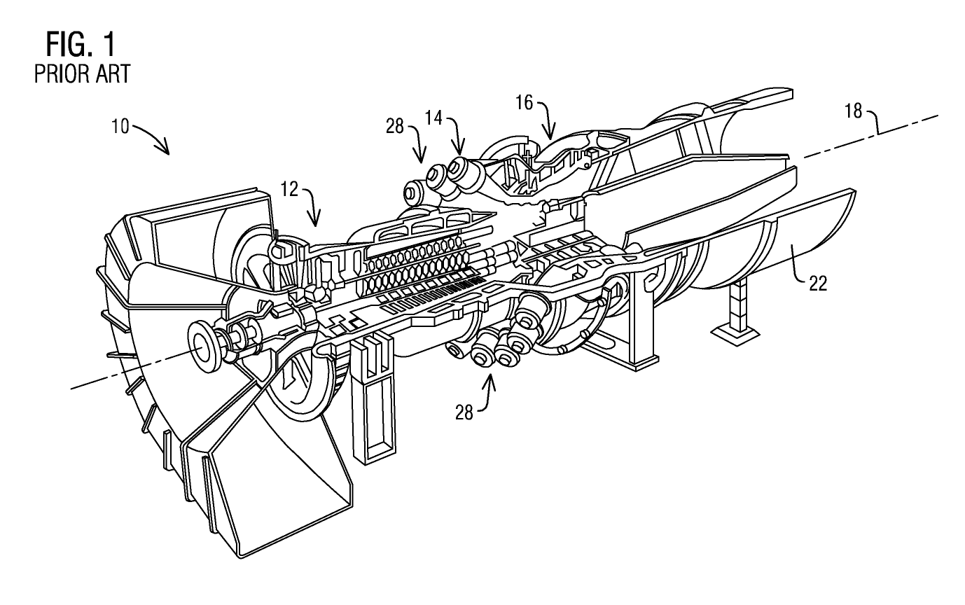

Referring to FIG. 1, an industrial gas turbine engine 10 is shown. The engine 10 includes a compressor section 12, a combustor section 14, and a turbine section 16 arranged along a horizontal center axis 18. The combustor section 14 includes a plurality of combustors 28. A hot working gas is conveyed from the combustor section 14 through to the turbine section 16.

A turbine 10 is typically operated for extended periods. This exposes the base metal to high temperatures, which may lead to oxidation of the base metal. The turbine 10 is inspected at periodic intervals to check for wear damage such as cracking and other undesirable conditions that may have occurred with respect to various internal components. For example, the thermal barrier coating (TBC) or both the TBC and bond coat layers may undesirably deteriorate or delaminate during operation of the turbine 10. Thus, turbine components are routinely inspected to determine the degree of deterioration of the TBC and bond coat layers.

Ultrasound may be used to excite the surfaces of a component by directing a pulsed laser at a desired surface of the component. The beam is absorbed by a shallow layer of the surface material causing vibrations. These vibrations may cause a flaw such as a crack to rub together heating up the area of the flaw. An infrared camera is effective to capture the infrared radiation created by the localized heating caused by the flaw in the form of thermographic images. The flaw would therefore be visible in the thermographic image.

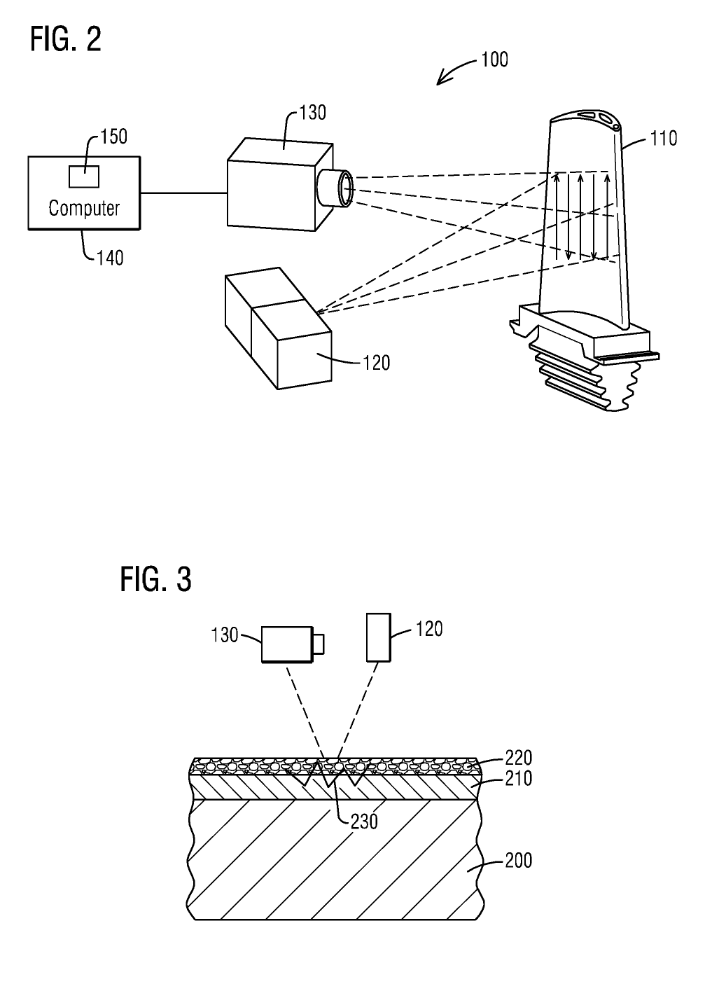

FIG. 2 is a diagrammatic illustration of a system 100 for performing acoustic thermography on a material according to an embodiment. The system 100 may be used to detect defects, such as cracks, corrosion, delaminations, disbonding etc. in a structure such as a turbine component 110 as shown. A turbine component 110 is shown to represent any structure or material that one skilled in the art may want to inspect for defects. Typically, gas turbine and aero-based components may include these types of defects. The material being examined may include metals, such as aluminium, metal alloys, such as stainless steel, and composites.

The illustrated system 100 includes an acoustic energy source such as a pulsed laser 120. In an embodiment, the pulsed laser 120 may be a short pulse laser that generates pulses of light in the nanosecond to femtosecond range. Short pulse lasers may be pulsed at a variety of ranges from 10 kHz to 100 kHz or modulated in most ranges. Additionally, the laser 120 may be a high peak power laser with an average power in the range of 80-200 W. Common lasers used for ultrasound generation are solid state Q-Switched Nd:YAG (yttrium aluminium garnet) and gas lasers. The laser 120 may include a scanning head in order to enable the laser to raster the laser beam.

In an embodiment, the system 100 includes a thermal imaging camera 130 spaced a predetermined distance from the turbine component 110 as shown. The thermal imaging camera 130 may be a midrange infrared camera (i.e. having a spectral range of approximately 3.0-5.0 m) or a long range infrared camera (i.e. having a spectral range of approximately 7.5-9.5 m), such as that available from FLIR Systems, Boston, Mass., US. The infrared (IR) camera 130 includes an infrared sensor for detecting thermal energy in the infrared region of the electromagnetic spectrum. The detected thermal energy is radiated by the turbine component 110 and transmitted to the infrared sensor. The IR camera 130 is configured to capture IR images of the turbine component 110. In the illustrated embodiment, a turbine blade is shown as the turbine component 110, however, one skilled in the art would understand that other turbine components, or materials as described above, may be used for the inspection as well. The IR sensor is communicatively coupled to a processor 150 by an electrical connection or a wireless connection.

The processor 150 may be a component of a computer 140 which may also include a memory, and an input/output interface. The computer 140 is generally coupled through the I/O interface to a display for visualization and various input devices that enable user interaction with the computer 140 such as a keyboard. For example, from the I/O interface a user may load the component 110 into the computer by identifying the type of component to be inspected. Using the identified type of component, the computer 140 may automatically position the camera according to pre-programmed positions stored in memory in order to capture a desired image.

When the material is embodied as a turbine component, in particular a turbine blade or vane as illustrated in FIG. 2, it may comprise a base layer 200, also called the substrate, overlaid with a bond coating to which a TBC is applied. FIG. 3 illustrates a cross section of such a coated turbine component. A substrate 200 is overlaid with a bond coating 210 to which a thermal barrier coating 220 is applied. The substrate 200 may comprise a superalloy material. The material may include a defect such as a crack 230. In the illustrated embodiment of FIG. 3, the bond coating 210 and the thermal barrier coating 220 include a crack 230, however, the crack may exist within any of the materials, including the substrate 200, shown or in a material such as a turbine component without a coating. The system 100 as described and shown in FIG. 2 is effective to capture a thermographic image of the crack 230 in the turbine component 110 and transmit the image to the processor 150. After the image is received by the processor 150, the image may be stored in memory and analyzed. This analysis may include assessing the condition of the turbine component 110.

Referring to FIGS. 1-3, a non-destructive method for condition assessment of a turbine component is also provided. A pulsed laser 120 may be provided to generate a sound wave within the turbine component 110 causing a defect 230, such as a crack, to vibrate. The laser may generate pulses of ultrasonic energy in a range of 1 kHz to 100 kHz; the frequency used depends upon the material tested. In one embodiment, the laser generates pulses of ultrasonic energy at a frequency of about 20 kHz for a period of time between 2-10 seconds depending on the size of the component. A generated sound wave in the range of 20 kHz would be effective to vibrate a crack 230 such that a thermal imaging camera would be able to capture an image of the crack 230. The pulsed laser 120 may be directed to excite a desired surface of the turbine component 110 from a distance in a range of 10 cm to 3 m. Utilizing the pulsed laser 120 from this distance makes it easier for a technician to access the turbine engine 10.

A thermographic image of the desired surface under the influence of the ultrasonic energy may be captured via an image receiver 130. The captured thermographic image is effective to indicate a defect 230 in the turbine component 110. Defects that may be seen in the thermographic image are cracks, corrosion, delaminations and/or disbonding which would be familiar to a technician skilled in the art. The image receiver 130 may be an infrared camera including an infrared sensor as described previously.

In an embodiment, the method may be an in-situ thermographic inspection of an internal component installed in a turbine engine. In-situ in this context means that the turbine component being inspected remains installed in the engine. In order to inspect the turbine component 110 in-situ, the pulsed laser 120 may be directed within the turbine casing 22 via a portal in the turbine casing 22 to a desired surface of a turbine component on the interior of the turbine casing 22. The image receiver may be positioned on the interior of the turbine casing 22 effective to capture the thermographic image of the desired surface. For example, in order to dispose the image receiver 130 within the interior of the turbine casing 22, a scope including the image receiver 130 may be inserted via the portal and remotely controlled via the computer 140 in order to capture the desired surface.

The acquired data may be analyzed in order to assess the condition of the turbine component 110. The analyzing may be accomplished by running algorithms on the computer 140 in order to process the acquired pixelated data. In an embodiment, assessing the condition of the turbine component 110 may include comparing the thermographic image of the desired area taken under the influence of the ultrasonic energy to a previous thermographic image, or known parameters, in order to determine whether a defect 230 has occurred during the time period between when the two images were images. In an embodiment, the assessment may include digitally subtracting a previous thermographic image of the turbine component 110, for example taken prior to development of a crack, from the captured thermographic image. The difference image may display the difference image showing thermographic changes between the two inspections. Defects or discontinuities will show up in a thermographic image as a different temperature change than normal surface or subsurface conditions.

An acoustic thermography method and system are thus presented utilizing a pulsed laser as an alternative excitation source. Laser acoustic thermography increases the probability of the detection of defects in materials, especially steel and high nickel alloy parts because scanning with the laser will increase the probability of detection by increasing the heating of the surface. For example, a laser may heat a surface of a material both by vibration and heating. Applying the ultrasound to the desired surface instead of using a transducer in direct contact with the material eliminates potential damage to the material. Moreover, laser acoustic coupling provides a capability of an in-situ inspection of components contained within a turbine casing. No disassembly of a turbine engine would be required other than removing a pilot nozzle and opening an inspection portion, for example. The turbine casing can remain installed around the combustion section. Even though the proposed method and system have been exemplified in this disclosure using a turbine engine and turbine components, particularly coated turbine components, one skilled in the art would recognize that the method and system may be applied to other materials and systems as well.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A non-destructive method for condition assessment of a turbine component, comprising:
providing a pulsed laser to excite a desired surface of the turbine component;
directing the pulsed laser at the desired surface to couple ultrasonic energy into the surface of the turbine component; and
capturing a thermographic image of the desired surface under the influence of the ultrasonic energy via an image receiver.

2. The method as claimed in claim 1, wherein the captured thermographic image is effective to indicate a defect in the turbine component.

3. The method as claimed in claim 2, wherein the defect is selected from the group consisting of cracks, corrosion, disbonding and delaminations.

4. The method as claimed in claim 1, wherein the condition assessment comprises an in-situ thermographic inspection of the turbine component installed in a turbine engine, further comprising:
directing the pulsed laser via a portal in a turbine casing of the turbine engine to the desired surface of the turbine component on the interior of the turbine casing, and
providing the image receiver on the interior of the turbine casing effective to capture the thermographic image of the desired surface.

5. The method as claimed in claim 1, wherein the pulsed laser is directed at the desired surface from a distance in a range of 10 cm to 3 m.

6. The method as claimed in claim 1, wherein the pulsed laser is a short-pulse laser.

7. The method as claimed in claim 6, wherein the pulsed laser is pulsed in a range from 10 kHz to 100 kHz.

8. The method as claimed in claim 1, further comprising assessing a condition of the turbine component using the thermographic image.

9. The method as claimed in claim 8, further comprising digitally subtracting a previous thermographic image of the turbine component from the thermographic image and displaying a difference image showing thermographic changes between two inspections.

10. The method as claimed in claim 1, wherein the image receiver is an infrared camera including an infrared sensor.

11. A system for the non-destructive detection of defects in a material utilizing acoustic thermography, comprising:
a pulsed laser to couple ultrasonic energy into the material;
an infrared camera comprising an infrared sensor configured to capture a thermographic image of the material under the influence of the ultrasonic energy produced as a result of the ultrasonic energy coupled into the material; and
a processor communicatively coupled to the infrared camera for receiving, storing, and analyzing the thermographic image.

12. The system as claimed in claim 11, wherein the captured thermographic image is effective to indicate a defect in the material.

13. The system as claimed in claim 11, wherein the material is selected from the group consisting of a metal alloy, a metal, a composite, and a ceramic.

14. The system as claimed in claim 13, wherein a surface of the material includes a thermal barrier coating, and
wherein a substrate of the material includes a bond coating and a substrate 200 or a substrate.

15. The system as claimed in claim 11, wherein the defect is selected from the group consisting of cracks, corrosion, disbanding, and delaminations.

16. The system as claimed in claim 11, wherein the infrared camera is a mid-wave infrared camera.

17. The system as claimed in claim 11, wherein the pulsed laser is a short-pulse laser.

18. The system as claimed in claim 17, wherein the pulsed laser is pulsed in a range from 10 kHz to 100 kHz.

19. A method for detecting defects in a material utilizing acoustic thermography, comprising:
providing a pulsed laser to excite a desired surface of the material;
directing the pulsed laser at the desired surface to couple ultrasonic energy into the surface of the material; and
capturing a thermographic image of the desired surface under the influence of the ultrasonic energy via an image receiver.

20. The method as claimed in claim 19, further comprising assessing a condition of the material by comparing the thermographic image with a previous thermographic image.
